(19) United States
(12) Patent Application Publication
(10) Pub. No.: US 2021/0345696 A1
(43) Pub. Date: Nov. 11, 2021

(54) FACE MASK WITH FILTER

(71) Applicant: Pound Cake Society, LLC, Los Angeles, CA (US)

(72) Inventor: Rana Massalkhi Farshoukh, Redondo Beach, CA (US)

(21) Appl. No.: 17/313,182

(22) Filed: May 6, 2021

Related U.S. Application Data
(60) Provisional application No. 63/021,057, filed on May 6, 2020.

(51) Int. Cl. A41D 13/11; A62B 23/02

(52) U.S. Cl. CPC A41D 13/113; A62B 23/025

(57) ABSTRACT

A face mask cover can include an outer panel, an inner panel sewn to the outer panel, and a filter panel positioned between the outer panel and the inner panel. A method of fabricating a face mask can include assembling with a sewn joint the face mask cover of the face mask, the face mask cover including an inner panel, an outer panel, and a filter panel; and turning the face mask cover inside out such that the filter panel is positioned between the inner panel and the outer panel.

### REFERENCE TO RELATED APPLICATIONS

This application claims the benefit of U.S. Provisional Application No. 63/021,057, filed May 6, 2020, which is hereby specifically incorporated by reference herein in its entirety.

### TECHNICAL FIELD

### Field of Use

This disclosure relates to face masks. More specifically, this disclosure relates to face masks with an integral nonwoven filter material.

### Related Art

A face mask can be helpful in protecting both an infected user and an uninfected user against transmission of communicable diseases. Under circumstances involving asymptomatic transmission, such protection can be even more valuable for an employee, health care worker, or member of the general public interacting with others. Public health officials have recently noted that face masks, if used properly, can help prevent the spread of respiratory droplets and help individuals to avoid touching their faces.

While surgical face masks can be manufactured from nonwoven fabrics such as polypropylene, such masks are not intended to be re-used and certainly cannot be properly cleaned and sterilized before re-use and instead are intended to be disposed after initial use. So-called “N95” respirators, while manufactured using multiple layers, for the same reason are also not intended to be re-used and require special tooling to mold the shape of the face mask during the manufacturing process.

### SUMMARY

It is to be understood that this summary is not an extensive overview of the disclosure.

This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a face mask cover comprising: an outer panel; an inner panel sewn to the outer panel; and a filter panel positioned between the outer panel and the inner panel.

In a further aspect, disclosed is a method of fabricating a face mask, the method comprising: assembling with a sewn joint a face mask cover of the face mask, the face mask cover comprising an inner panel, an outer panel, and a filter panel; and turning the face mask cover inside out such that the filter panel is positioned between the inner panel and the outer panel.

In a further aspect, disclosed is a method of using a face mask, the method comprising:

obtaining the face mask, the face mask comprising a face mask cover comprising an inner panel, an outer panel, and a filter panel positioned between the inner panel and the outer panel, the inner panel and the outer panel assembled with a sewn joint, wherein each of the outer panel and the inner panel comprise cotton and the filter panel comprises a non-woven material; and securing the face mask to a face of a user with straps of the face mask extending from the face mask cover, the inner panel of the face mask cover facing the face of the user.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and together with the description, serve to explain various principles of the disclosure. The drawings are not necessarily drawn to scale. Corresponding features and components throughout the figures may be designated by matching reference characters for the sake of consistency and clarity.

FIG. 1 is a front view of a face mask in accordance with one aspect of the current disclosure.

FIG. 2 is a sectional view of the face mask of FIG. 1 taken along line 2-2 of FIG. 1.

FIG. 3 is a rear perspective view of a face mask cover of the face mask of FIG. 1 with inside surfaces of the face mask cover shown facing out.

FIG. 4 is a front perspective view of the face mask cover of FIG. 2 with the inside surfaces of the face mask cover shown facing out.

FIG. 5 is a side perspective view of an assembled inner panel and the filter panel of the face mask cover of FIG. 2.

FIG. 6 is a side perspective view of an assembled outer panel of the face mask cover of FIG. 2.

FIG. 7 is a front perspective view of the face mask of FIG. 1 in accordance with another aspect of the current disclosure.

FIG. 8 is a rear perspective view of the face mask of FIG. 7.

FIG. 9 is a front perspective view of the face mask of FIGS. 7 and 8 as worn by a user of the face mask.

FIG. 10 is a front perspective view of the face mask of FIG. 1 in accordance with another aspect of the current disclosure.

FIG. 11 is a side perspective view of the face mask of FIG. 10 as worn by the user of the face mask.

FIG. 12 is a front perspective view of the face mask of FIG. 1 in accordance with another aspect of the current disclosure.

FIG. 13 is a front perspective view of the face mask of FIG. 1 in accordance with another aspect of the current disclosure.

FIG. 14 is a rear perspective view of the face mask of FIG. 13 in accordance with another aspect of the current disclosure, the face mask comprising a nose guard extending in a first direction.

FIG. 15 is a rear perspective view of the face mask of FIG. 14 in accordance with another aspect of the current disclosure, the face mask comprising a stiffening member extending in a second direction.

FIG. 16 is a rear perspective view of the face mask of FIG. 14 in accordance with another aspect of the current disclosure, the face mask comprising a nose guard extending along and within a hem of the face mask.

FIG. 17 is a rear perspective view of the face mask of FIG. 14 in accordance with another aspect of the current disclosure, the face mask comprising a nose guard housed within a cover.

FIG. 18 is a rear perspective view of the face mask of FIG. 14 in accordance with another aspect of the current disclosure, the face mask comprising a stiffening member housed within a cover.

FIG. 19 is an exploded view of the face mask of FIG. 14 showing the outer panel, the inner panel, the filter panel, and the hem of the face mask.

FIG. 20 is a selection of materials from which a filter panel of the face mask of FIG. 2 is formed.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end or side of the face mask facing outward from a user of the face mask; “rear” is that end of side of the face mask that is opposite or distal the front and generally facing inward towards the user; “left” is that which is to the left of or facing left from the user while facing towards the front; and “right” is that which is to the right of or facing right from the user while facing towards the front. “Horizontal” or “horizontal orientation” describes that which is in a plane extending from left to right and aligned with the horizon. “Vertical” or “vertical orientation” describes that which is in a plane that is angled at 90 degrees to the horizontal.

In one aspect, a face mask and associated methods, systems, devices, and various apparatuses are disclosed herein. In one aspect, the face mask can comprise a non-woven panel assembled to a cotton panel.

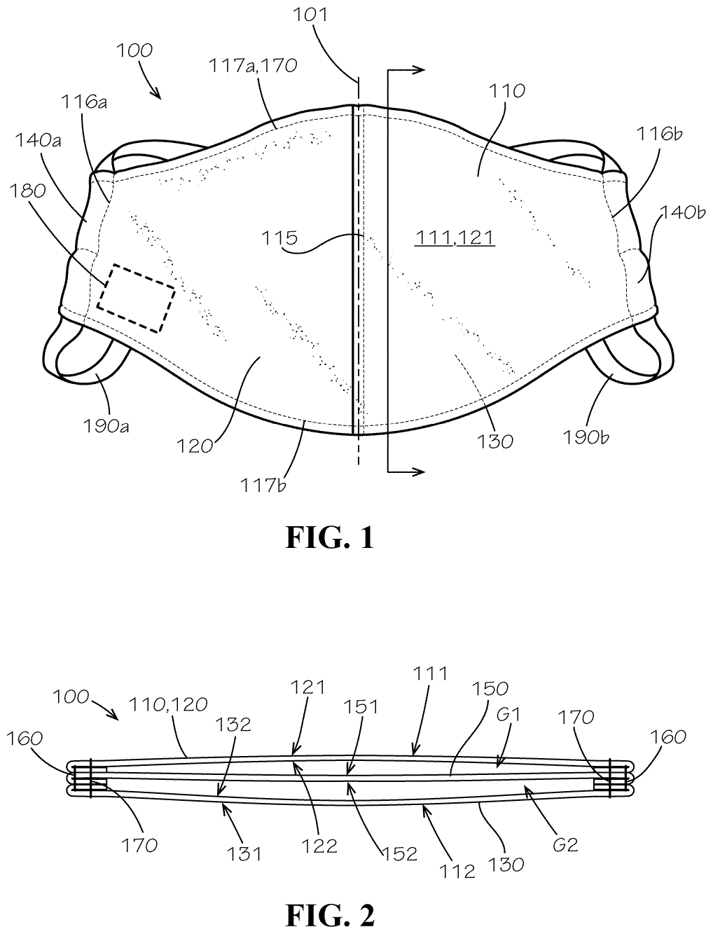

FIG. 1 is a front view of a face mask 100 in accordance with one aspect of the current disclosure. As shown, the face mask 100 can comprise a face mask cover 110 defining an outer surface 111 and an inner surface 112 (shown in FIG. 2). The face mask cover 110 can comprise an outer panel 120 and an inner panel 130 (shown more directly in FIGS. 2 and 7). The outer panel 120 can define an outer surface 121 and an inner surface 122 (shown in FIG. 2), and the inner panel 130 can define an outer surface 131 (shown in FIG. 2) and an inner surface 132 (shown in FIG. 2). The face mask cover 110 can comprise a filter panel 150 (shown in FIG. 2), which can itself define an outer surface 151 (shown in FIG. 2) and an inner surface 152 (shown in FIG. 2) and can be positioned between the outer panel 120 and the inner panel 130. In some aspects, as shown, each of the outer panel 120, the inner panel 130, and the filter panel 150 can be formed from a plurality of subpanels of material, which can be joined at various seams such as, for example and without limitation, a central seam 115, side or longitudinal seams 116a,b, and top/bottom or latitudinal seams 117a,b. In some aspects, each of the outer panel 120, the inner panel 130, and the filter panel 150 can be formed from a single piece of material. As shown, the face mask 100 can be symmetric about a centerline or central axis 101.

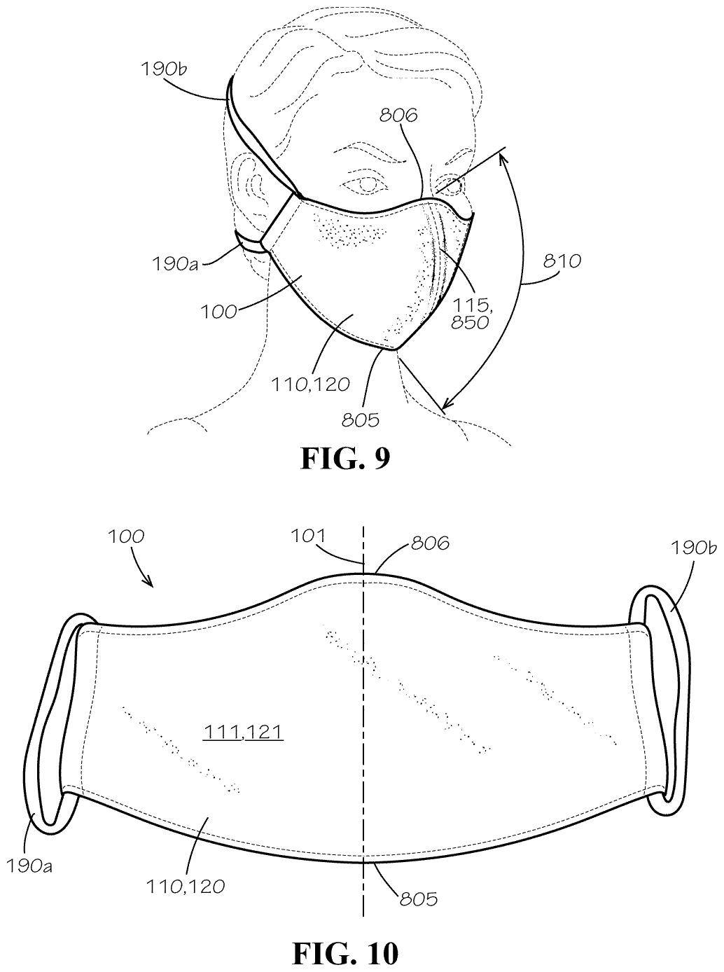

The face mask 100 can comprise straps 190a,b, which can be secured to the face mask cover 110 and can secure the face mask cover 110 to a face of a user (as shown in FIG. 9). The straps 190a,b can be formed from an elastic material configured to facilitate attachment to a face of a user. The straps 190a,b can extend through or adjacent to a portion of the face mask cover 110 such as side channels or ends 140a,b. In some aspects, either of the straps 190a,b can be fixed with respect to and even secure to or be secured to the ends 140a,b. In some aspects, the straps 190a,b can be allowed to move with respect to the face mask cover 110 and even be replaced without modification or disassembly of the face mask cover 110.

As will be described below, edges of the face mask cover 110 can define various straight edges and curved edges to satisfy ergonomic requirements as well as aesthetic (and also non-functional) considerations. For promotional or other purposes, the face mask 100 can define graphics 180 on a surface of the face mask cover 110, on the straps 190a,b, or on any other portion thereof as desired. In some aspects, the graphics 180 can be a logo or mark or other design partially or completely covering just a portion of the face mask cover 110 in any desired orientation. In some aspects, the graphics 180 can cover as much as an entire surface of the face mask cover 110 and can cover any surface such as the outer surface 111 and can define a regular or irregular pattern or no pattern. The graphics 180 can be formed as part of the material forming such a surface or can be applied to such a surface.

FIG. 2 is a sectional view of the face mask 100 taken along line 2-2 of FIG. 1. While the thicknesses and other dimensions can be considered exaggerated and each of the outer panel 120, the inner panel 130, and the filter panel 150 are shown relatively flattened for the sake of clarity, adjacent pair of layers of the outer panel 120, the inner panel 130, and the filter panel 150 can define gaps G1,G2 therebetween as shown. When the face mask cover 110 forms a three-dimensional shape defining a cavity to receive a face of a user, each of the three layers in FIG. 2 can individually and collectively define a curved hat or “hill” shape, although any shape is generally possible depending on the desired end shape of the face mask cover 110. As shown, the face mask cover 110 can comprise an internal joint 160 and an external joint 170 joining two or more of the outer panel 120, the inner panel 130, and the filter panel 150. Either or both of the internal joint 160 and the external joint 170 can be a sewn joint. The face mask cover 110 can comprise as many as one or more similar internal joints and external joints, any of which can be a sewn joint, proximate to or at the central seam 115 (shown in FIG. 1) to join subpanels of any of the outer panel 120, the inner panel 130, and the filter panel 150 or for aesthetic considerations. Described also below, a metal nose guard 250 (shown in FIG. 14) can be formed from a thin plate or strip of metal such as, for example and without limitation, corrosion-resistant stainless steel, and can optionally be positioned in alignment with the central seam 115 and below and offset from a second or upper end 806 of the face mask cover 110. Similarly, a stiffening rib or member 850 (shown in FIG. 9) can be positioned in alignment with the central seam 115 along any portion of the central seam 115 or along the entire central seam 115.

Either or both of the outer panel 120 and the inner panel 130 can comprise cotton. More specifically, either or both of the outer panel 120 and the inner panel 130 can be made from 100% cotton. Cotton, which is a type of natural cellulosic fiber, can withstand heat, detergents, and bleach, all of which can be exposed to the face mask cover 110 and the face mask 100 when cleaned. More specifically, either or both of the outer panel 120 and the inner panel 130 can be made from poplin, which is a durable, lightweight cotton. In some aspects, the average poplin weight can be around 100 grams per square meter of material. In some aspects, the average poplin weight can be between 88 and 150 grams per square meter of material. Cotton, being also breathable (i.e., permeable by air in volumes breathable by a user), can allow air movement through the face mask 100 during breathing, and by itself has been recommended for homemade face masks due to its ability to prevent passage of some droplets and to discourage users from touching their faces and especially their mouths and noses. Cotton can come in different weights and thicknesses, often determined by yarn thickness. One method of measuring thickness is denier, and in some aspects, either or both of the outer panel 120 and the inner panel 130 can have a thickness of at least 40 denier or 40 d. In some aspects, either or both of the outer panel 120 and the inner panel 130 can have a thickness of at least 50 denier or 50 d.

The filter panel 150 can comprise a non-woven material. More specifically, the filter panel 150 can be made from polypropylene non-woven material or a polypropylene-based non-woven material. More specifically, the non-woven material can comprise thermally bonded polypropylene, which can be a spunbond polypropylene (SBPP) available from STC-QST LLC, an apparel component supplier located in Los Angeles, Calif. Polypropylene (PP), which is a thermoplastic “addition polymer” made from a combination of propylene monomers, can be a cost-effective plastic material for use in a medical environment and, being cleanable and sterlizable like cotton, can generally be used where steam-sterilized medical devices are necessary. In addition to having resistance to steam sterilization, mechanical performance properties of polypropylene include durability for re-use. In addition, polypropylene is certifiably free of bisphenol A (BPA) and free of other bisphenols as well. Polypropylene, considered by some to be the safest of all plastics, has a high heat tolerance and is therefore unlikely to leach (i.e., release chemicals) even when exposed to warm or hot water. By being thermally bonded, the polypropylene used to form the filter panel 150 becomes a tightly woven barrier able to resist passage of bacteria and viruses and yet also be breathable. Even if a particle is able to pass through the filter panel 150 comprising the thermally bonded polypropylene, such passage will be slowed and made more circuitous. In some aspects, the polypropylene material used in the filter panel 150 can comprise titanium dioxide material and, more specifically, can comprise titanium dioxide material in an amount equal to 1% percent by weight.

While in some aspects the filter panel 150 can be made removable from the face mask cover 110 and the face mask 100, the filter panel 150 can be permanently assembled to or incorporated into the face mask cover 110 to eliminate various risks including the risk of improperly handling the filter panel 150 in a contaminated state, the risk of improperly cleaning and re-installing the filter panel 150, and the risk of losing the filter panel 150 and nonetheless using the face mask 100 without the filter panel 150.

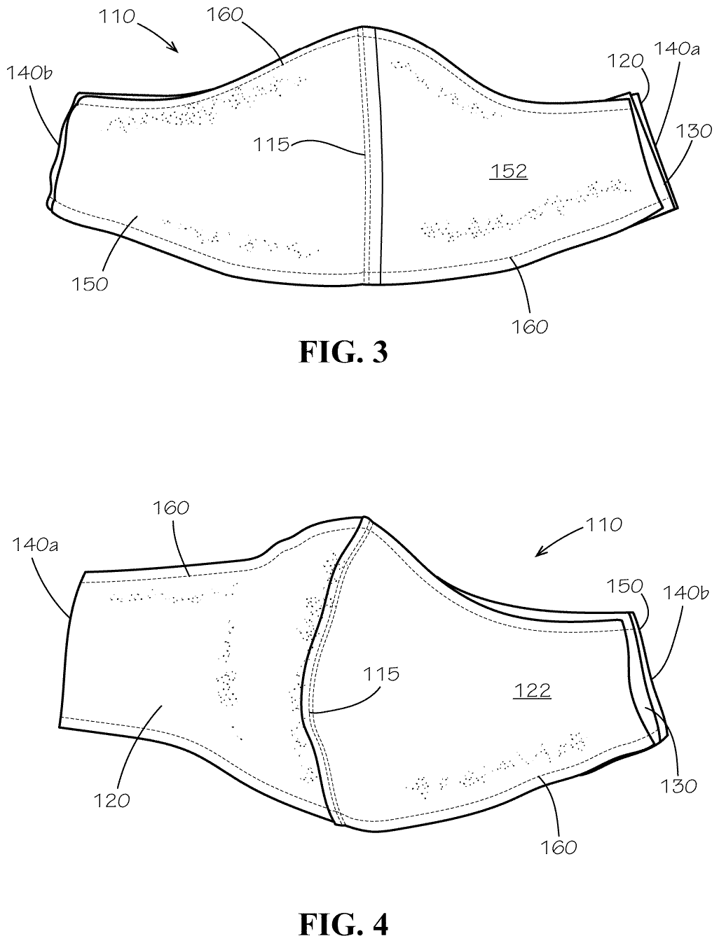

FIGS. 3 and 4 are perspective views of the face mask cover 110 of the face mask 100 with inside or inner surfaces shown facing out. FIG. 3 is a rear perspective view of the face mask cover 110 of the face mask 100 (shown in FIG. 1) with inner surfaces such as the inner surface 152 of the filter panel 150 of the face mask cover 110 shown facing out. As shown, the outer panel 120, the inner panel 130, and the filter panel 150 can be stacked during assembly, with the edges of each at least roughly aligned. FIG. 4 is a front perspective view of the face mask cover 110 with the inside surfaces such as the inner surface 122 of the outer panel 120 of the face mask cover 110 shown facing out, although FIG. 4 could just as easily show or represent the inner surface 132 of the inner panel 130 of the face mask cover 110 instead, in which case the outer panel could be positioned between the inner panel 130 and the filter panel 150. As shown, the internal joints 160 can extend between the ends 140a,b.

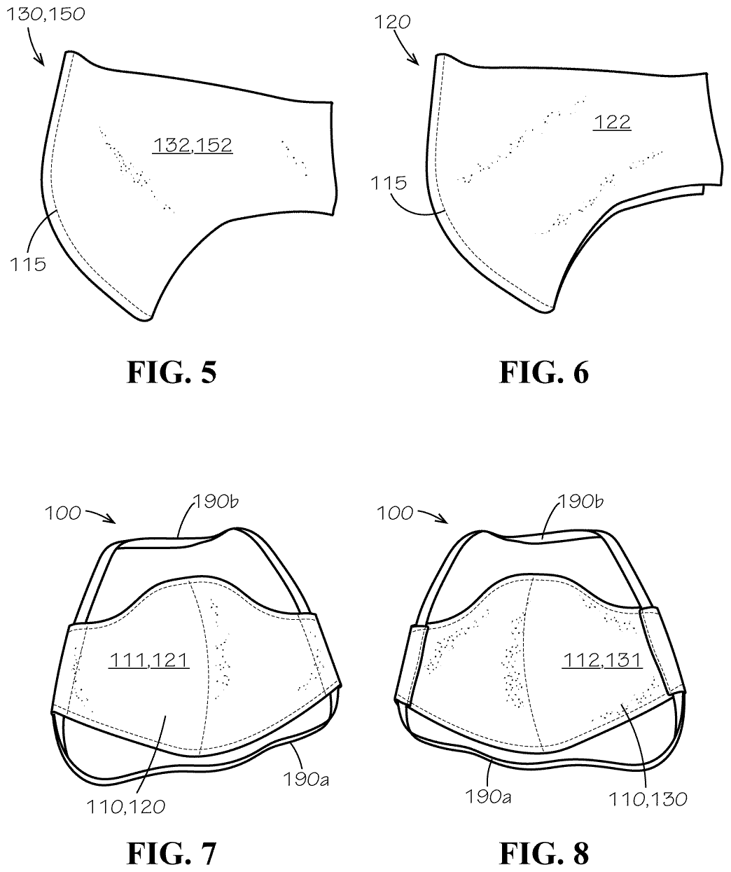

FIGS. 5 and 6 are side perspective views of portions of the face mask cover 110 before assembly. FIG. 5 is a side perspective view of the assembled subpanels of the inner panel 130 and the filter panel 150 of the face mask cover 110 as folded in half. FIG. 6 is a side perspective view of the assembled subpanels of the outer panel 120 of the face mask cover 110 as folded in half. As shown , edges of the material forming the outer panel 120, the inner panel 130, and the filter panel 150 can extend beyond the internal joint 160 and the internal joint 160 can thereby be offset from such an edge and vice versa. With such an offset or hem the internal joint 160 can securely hold the outer panel 120, the inner panel 130, and the filter panel 150 together during assembly and use of the face mask 100, even when the edge is partially unraveled or stress is applied to the internal joint 160. A pattern or template, which can be followed or used in the process of forming the outer panel 120, the inner panel 130, and the filter panel 150 and any subpanels thereof, can therefore be cut or formed larger than the final dimensions of the face mask cover 110 in consideration of such an offset.

FIGS. 7 and 8 are front and rear perspective views of the face mask 100 in accordance with another aspect of the current disclosure. As shown, the straps 190a,b can be configured to extend around and over a head of the user by making them sufficiently long and flexible for a large variety of head sizes (including head circumferences). By extending the straps 190a,b around and over the head of the user, the straps 190a,b can be adjustable and the face mask 100 can be less apt to fall off if and when pulled down because the face mask 100 can hang safely around a neck of the user.

FIG. 9 is a front perspective view of the face mask 100 of FIGS. 7 and 8 as worn by a user of the face mask 100. As shown, the face mask cover 110 can extend a distance 810 across a face of the user. The face mask cover 110 can extend to and even below a chin of the user at a first or lower end 805 and to and above a nose of the user at a second or upper end 806 of the face mask cover 110. A three-dimensional shape of the face mask 100 can snugly but comfortably fit a contour of the face of the user. In some aspects, the face mask 100 can be worn with a point thereof defined by the upper end 806 positioned over the nose of the user. In some aspects, the face mask 100 can be worn in an opposite orientation with the first end 805 positioned under the chin of the user and the second end 806 positioned over the nose. The aforementioned metal nose guard 250 can be secured to the face mask cover 110 proximate to the second end 806 or the first end 805 to allow the user to deform the face mask cover 110 to follow a shape of the nose more closely and to maintain such a deformed shape.

In some aspects, the face mask 100 can further comprise the stiffening member 850, which can comprise a boning material. The stiffening member 850 can be a stay or a rib. The stiffening member 850 can be configured to hold the inner panel 130 of the face mask cover 110 away from a face of the user at a position proximate to a mouth of the user, thereby forming a pocket between the face mask cover 110 and the user's mouth. The stiffening member 850 can comprise or be formed from any one of a number of materials including, for example and without limitation, a partially stiff and partially flexible plastic such as polyester including the type described as RIGILENE polyester boning. The stiffening member 850, which can define a relatively thin rectangular shape in cross-section, can be sewn into a seam of the face mask 100 such as, for example and without limitation, the central seam 115. The stiffening member 850 can be positioned between the outer panel 120 and the inner panel 130 (shown in FIG. 2) and thereby hidden inside the face mask cover 110.

FIG. 10 is a front perspective view of the face mask of FIG. 1 in accordance with another aspect of the current disclosure. As shown, the straps 190a,b can be configured to extend around and over ears of the user. By extending the straps 190a,b around and over the ears of the user, the user's hair can be left largely if not completely undisturbed.

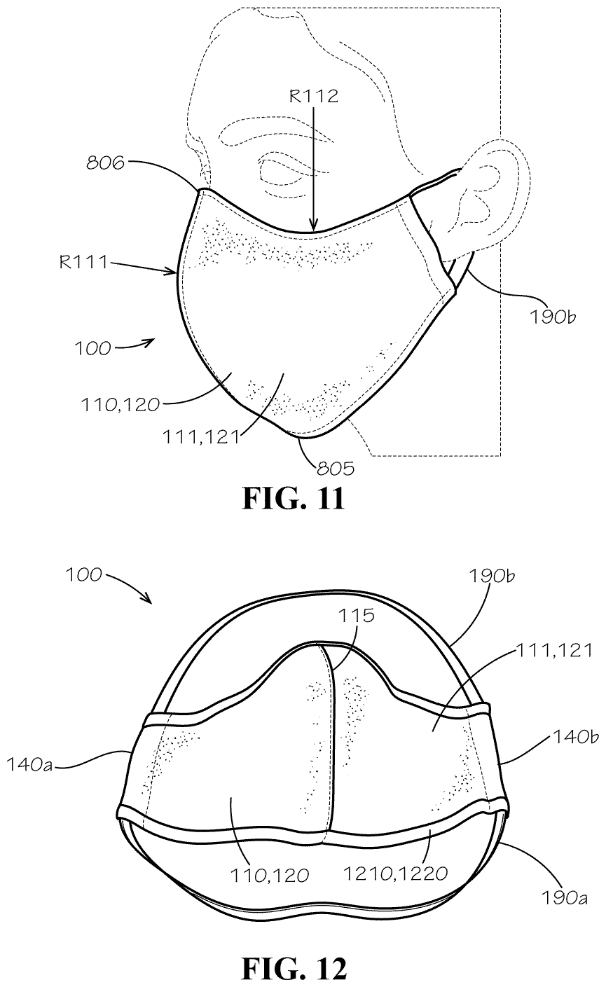

FIG. 11 is a side perspective view of the face mask 100 of FIG. 9 as worn by the user of the face mask 100. As shown, the outer panel 120 of the face mask cover 110 can define a radius R111 at the outer surfaces 111,121. In some aspects, the radius R111 can be maintained by the stiffening member 850 (shown in FIG. 9). The face mask cover 110 can define a radius R112, which can facilitate comfort for the user by maintaining an edge of the face mask cover 110 at a distance from the eye and also smoothly transitioning to the ends 140a,b of the face mask cover 110, which can be narrower than the distance 810 (shown in FIG. 9) defined along a central axis 101 of the face mask 100.

FIG. 12 is a front perspective view of the face mask 100 in accordance with another aspect of the current disclosure. As shown, a separate hem material—even a contrasting material, can extend around a perimeter 1210 of the face mask cover 110 to form a hem 1220 of the face mask cover 110. In some aspects, the hem 1220 can comprise an elastic material to facilitate a snug but comfortable fit against a face of the user.

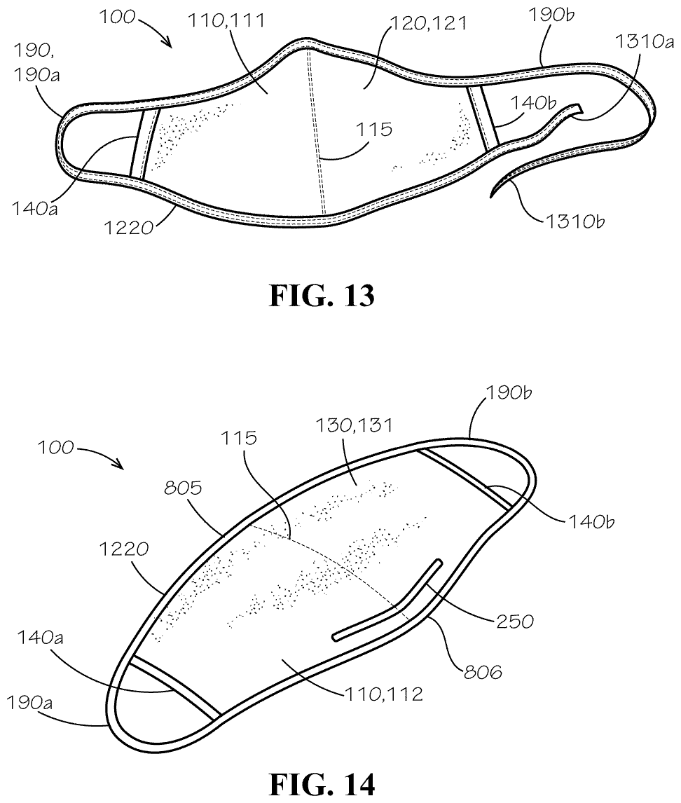

FIG. 13 is a front perspective view of the face mask of FIG. 1 in accordance with another aspect of the current disclosure. As shown, material forming a strap 190 of the face mask 100a can also form the hem 1220. As also shown, the strap 190 of the face mask 100b can be discontinuous, and ends 1310a,b can be tied at a desired length to accommodate a shorter or longer distance to an ear of the user.

FIG. 14 is a rear perspective view of the face mask 100 of FIG. 13 in accordance with another aspect of the current disclosure. In some aspects, as shown, the nose guard 250 can extend in a first direction, which can be a left-to-right direction extending from the end 140a to the end 140b. More specifically, the nose guard 250 can be secured to any one of the outer panel 120, the inner panel 130 (as shown), and the filter panel 150. In some aspects, as shown, a shape or contour of the nose guard 250 can match a shape or contour of an edge of the face mask cover 110 such as shown proximate to the upper end 806 of the face mask 100. More specifically, the nose guard 250 can be offset by a constant distance from an edge of the face mask 100. The nose guard can be secured to the face mask cover 110 or any portion thereof with adhesive, stitching, or any other mechanical method.

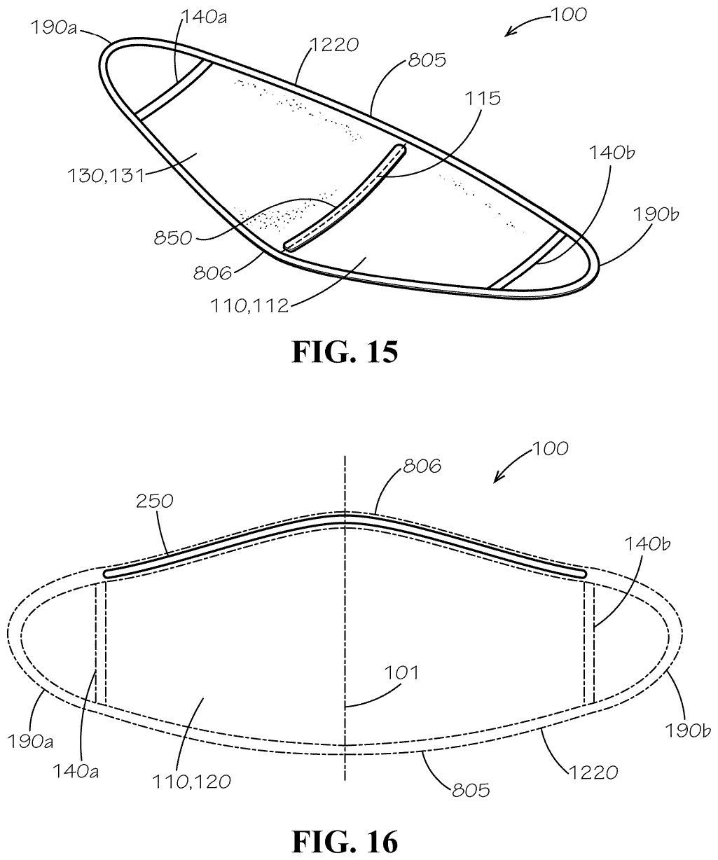

FIG. 15 is a rear perspective view of the face mask 100 of FIG. 14 in accordance with another aspect of the current disclosure. In some aspects, as shown, the stiffening member 850 can extend in a second direction, which can be a bottom-to-top direction extending from the lower end 805 to the upper end 806.

FIG. 16 is a rear perspective view of the face mask 100 of FIG. 14 in accordance with another aspect of the current disclosure. In some aspects, as shown, the nose guard 250 can extend along and within the hem 1220 of the face mask 100. More specifically, the nose guard 250 can extend a full length of the hem between the ends 140a,b. By extending the nose guard 250 a longer distance, a shape of a portion of the face mask 100 can be adjusted by deformation of the nose guard 250 to match a contour of a larger portion of the face of a user where the face mask 100 comes into contact with the face of the user.

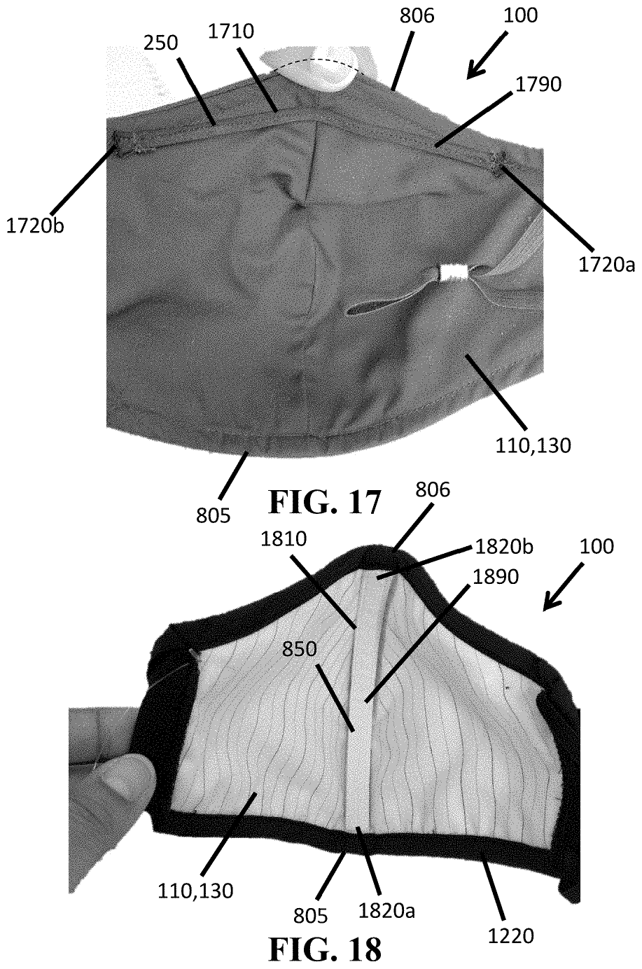

FIG. 17 is a rear perspective view of the face mask 100 of FIG. 14 in accordance with another aspect of the current disclosure. As shown, the nose guard 250 can be housed within a cover 1710, which can be a sleeve. In some aspects, the cover 1710 can be secured to the face mask cover 110 along a length of the cover 1710 with a seam or stitching 1790, which can define a sewn joint, or the cover 1710 can otherwise be formed with or comprise the seam or stitching 1790. In some aspects, the cover 1710 can be secured to the face mask cover 110 at cover ends 1720a,b, each of which can comprise a seam or stitching and can define a sewn joint. More specifically, in either or both aspects, the cover 1710 can be secured to the inner panel 130 of the face mask cover 110. In some aspects, the nose guard 250 can additionally be encased within an intermediate cover (not shown), which can also be a sleeve and can be formed from a flexible material such as plastic. Together with the intermediate cover, the nose guard 250 be housed within the cover 1710.

FIG. 18 is a rear perspective view of the face mask 100 of FIG. 14 in accordance with another aspect of the current disclosure. As shown, the stiffening member 850 can be housed within a cover 1810, which can be a sleeve. In some aspects, the cover 1810 can be secured to the face mask cover 110 at cover ends 1820a,b, each of which can comprise a seam or stitching and can define a sewn joint. In some aspects, the cover 1810 can be secured to the face mask cover 110 along a length of the cover 1810 with a seam or stitching 1890, which can define a sewn joint, or the cover 1810 can otherwise be formed with or comprise the seam or stitching 1890. Either of the covers 1710,1810 can be formed from a flexible material such as fabric, which can protect surrounding portions of the face mask 100 from the direct contact with the nose guard 250 or the stiffening member 850, a material for which can be inherently harder and more rigid than that forming any of the panels 120,130,150 or the straps 190a,b.

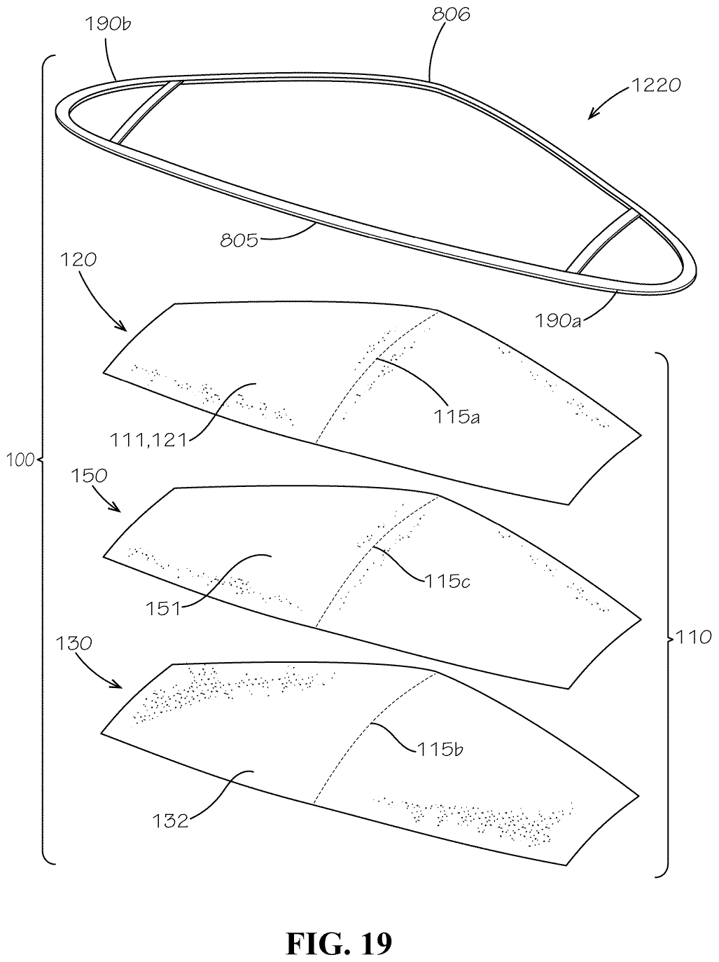

FIG. 19 is an exploded view of the face mask 100 of FIG. 14 showing the outer panel 120, the inner panel 130, the filter panel 150, and the hem 1220 of the face mask 100. As shown, each of the outer panel 120, the inner panel 130, and the filter panel 150 of the face mask cover 110 can define or comprise individual seams 115a,b,c, respectively. In some aspects, each of the outer panel 120, the inner panel 130, and the filter panel 150 need not define any seam and, again, can be a single piece of material. As shown, the outer panel 120, the inner panel 130, and the filter panel 150 can define the same overall dimensions, or the filter panel 150 can otherwise extend completely across the face mask cover 110—between the ends 140a,b and between the ends 805,806.

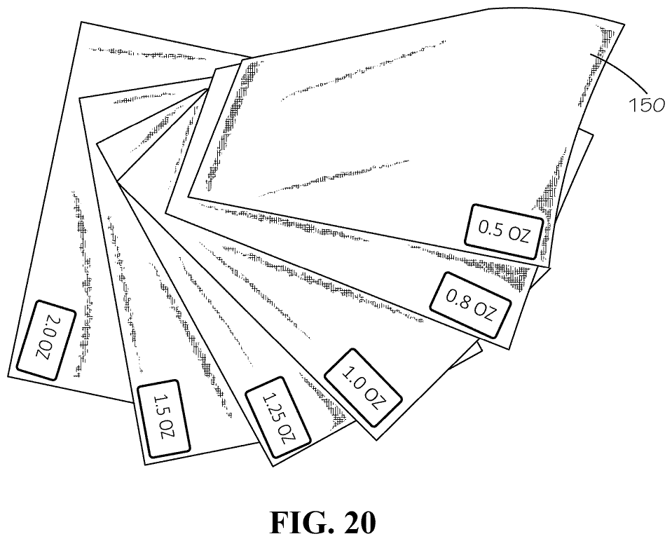

FIG. 20 shows a selection of materials from which the filter panel 150 can be formed. In some aspects, a material such as the aforementioned thermally bonded polypropylene material can have or define a weight of at least 0.5 ounces as shown. In some aspects, a material such as the aforementioned thermally bonded polypropylene material can have or define a weight of at least 0.8 ounces as shown. In some aspects, a material such as the aforementioned thermally bonded polypropylene material can have or define a weight of at least 1.0 ounces as shown. In some aspects, a material such as the aforementioned thermally bonded polypropylene material can have or define a weight of at least 1.25 ounces as shown. In some aspects, a material such as the aforementioned thermally bonded polypropylene material can have or define a weight of at least 1.5 ounces as shown. In some aspects, a material such as the aforementioned thermally bonded polypropylene material can have or define a weight of at least 2.0 ounces as shown. In some aspects, a material such as the aforementioned thermally bonded polypropylene material can have or define a weight of between 1.0 and 2.0 ounces.

A method of fabricating or manufacturing the face mask 100 can comprise assembling with a sewn joint such as the internal joint 160 or the external joint 170 a face mask cover 110 of the face mask. The method can comprise turning the face mask cover 110 inside out such that the filter panel 150 is positioned between the inner panel 130 and the outer panel 120. The method can comprise assembling the face mask 100 with a stiffening member 850 configured to hold the inner panel 130 of the face mask cover 110 away from a face of the user at a position proximate to a mouth of the user. In some aspects, the method can comprise roughly shaping the face mask cover 110 to follow the contours of the user's face. In some aspects, the method can comprise shaping the face mask cover 110 to fit snugly against and seal against the contours of the user's face. In some aspects, the method can comprise securing the nose guard 250 to the face mask cover 110 to allow the user to deform the face mask cover 110 to follow a shape of the nose more closely and to maintain such a deformed shape indefinitely. More specifically, the method can comprise inserting the nose guard 250 into the cover 1710 and can comprise securing the cover 1710 to the face mask cover 110. Similarly, the method can comprise inserting the stiffening member 850 into the cover 1810 and can comprise securing the cover 1810 to the face mask cover 110. The method can comprise encasing the nose guard 250 in an intermediate cover.

A method of using the face mask 100 can comprise stretching the straps 190a,b to extend and secure around either the ears of the user or around the entire head of the user. The method can further comprise cleaning, sterilizing, and re-using the face mask 100.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A face mask cover comprising:
an outer panel;
an inner panel sewn to the outer panel; and
a filter panel positioned between the outer panel and the inner panel.

2. The face mask cover of claim 1, wherein each of the outer panel and the inner panel comprises cotton and the filter panel comprises a non-woven material.

3. The face mask cover of claim 2, wherein each of the outer panel and the inner panel is made from 100% cotton.

4. The face mask cover of claim 2, wherein the non-woven material comprises thermally bonded polypropylene.

5. The face mask cover of claim 2, wherein the face mask cover is washable.

6. The face mask cover of claim 2, wherein:
the outer panel and the filter panel define a first gap therebetween,
the inner panel and the filter panel define a second gap therebetween; and
each of the first gap and the second gap is able to receive and hold air.

7. The face mask cover of claim 1, wherein a perimeter of the face mask cover is trimmed with a separate hem, the hem comprising an elastic material.

8. A face mask comprising the face mask cover of claim 1 and further comprising a pair of straps configured to secure the face mask cover to a face of a user.

9. The face mask of claim 8, further comprising a stiffening member positioned behind the outer panel.

10. A method of fabricating a face mask, the method comprising:
assembling with a sewn joint a face mask cover of the face mask, the face mask cover comprising an inner panel, an outer panel, and a filter panel; and
turning the face mask cover inside out such that the filter panel is positioned between the inner panel and the outer panel.

11. The method of claim 10, wherein each of the outer panel and the inner panel comprise cotton and the filter panel comprises a non-woven material.

12. The method of claim 11, wherein each of the outer panel and the inner panel are made from 100% cotton.

13. The method of claim 11, wherein the non-woven material comprises thermally bonded polypropylene.

14. The method of claim 10, further comprising assembling the face mask with a stiffening member configured to hold the inner panel of the face mask cover away from a face of a user at a position proximate to a mouth of the user.

15. The method of claim 10, further comprising:
forming each of the inner panel and the outer panel with a plurality of subpanels; and
joining the plurality of subpanels of each of the inner panel and the outer panel with a sewn joint.

16. A method of using a face mask, the method comprising:
obtaining the face mask, the face mask comprising a face mask cover comprising an inner panel, an outer panel, and a filter panel positioned between the inner panel and the outer panel, the inner panel and the outer panel assembled with a sewn joint, wherein each of the outer panel and the inner panel comprise cotton and the filter panel comprises a non-woven material; and
securing the face mask to a face of a user with straps of the face mask extending from the face mask cover, the inner panel of the face mask cover facing the face of the user.

17. The method of claim 16, wherein the non-woven material comprises thermally bonded polypropylene.

18. The method of claim 16, further comprising:
removing the face mask; and
cleaning the face mask.

19. The method of claim 18, wherein cleaning the face mask comprises sterilizing the face mask with a steam-sterilization process.

20. The method of claim 18, further comprising re-using the face mask.
